(19) United States
(12) Patent Application Publication
(10) Pub. No.: US 2024/0351887 A1
(43) Pub. Date: Oct. 24, 2024

(54) Q-SILICON SYNTHESIS, PROPERTIES AND APPLICATIONS

(71) Applicant: North Carolina State University, Raleigh, NC (US)

(72) Inventors: Jagdish Narayan, Raleigh, NC (US); Roger J. Narayan, Raleigh, NC (US)

(21) Appl. No.: 18/642,319

(22) Filed: Apr. 22, 2024

Related U.S. Application Data
(60) Provisional application No. 63/528,091, filed on Jul. 21, 2023.
(60) Provisional application No. 63/461,015, filed on Apr. 21, 2023.

(51) Int. Cl. C01B 33/021; H01M 4/02; H01M 4/1395; H01M 4/62

(52) U.S. Cl. CPC C01B 33/021; H01M 4/1395; H01M 4/623; C01P 2002/54; C01P 2002/82; C01P 2004/01; C01P 2006/40; C01P 2006/42; H01M 2004/027

(57) ABSTRACT

Various examples are provided related to Q-silicon, Q-carbon and combinations thereof, and synthesis, properties and applications of Q-silicon and Q-carbon. In one example, a method includes forming a layer of amorphous silicon; melting at least a portion of the layer of amorphous silicon in an undercooled state; and forming Q-silicon by quenching the melted amorphous silicon from the undercooled state. In another example, a Q-silicon includes a random arrangement of tetrahedra, the tetrahedra including dangling bonds, unpaired spins or both. The atomic structure of the Q-silicon is based upon time in an undercooled state before quenching. In another example, a battery anode includes Q-silicon mixed with a polyvinylidene difluoride (PVDF) binder, the Q-silicon including a random arrangement of tetrahedra, the tetrahedra comprising dangling bonds, unpaired spins or both. The battery anode can include Q-carbon and Q-silicon mixed with the PVDF binder.

### CROSS REFERENCE TO RELATED APPLICATIONS

This application claims priority to, and the benefit of, U.S. provisional application entitled “Q-Silicon Synthesis, Properties and Applications” having Ser. No. 63/461,015, filed Apr. 21, 2023, and U.S. provisional application entitled “Q-Carbon and Q-Silicon Anodes to Create High-Performance Batteries” having Ser. No. 63/528,091 filed Jul. 21, 2023, both of which are hereby incorporated by reference in their entireties.

### STATEMENT REGARDING FEDERALLY SPONSORED RESEARCH OR DEVELOPMENT

This invention was made with government support under grant numbers CBET1836767 and ECCS2029974 awarded by the National Science Foundation. The government has certain rights in the invention.

### BACKGROUND

Pursuit of ferromagnetism in materials outside of transition metals and rare earths has excited scientists worldwide for a long time. This is because spin-polarized electrons can be used to process and store information with atomic resolution. However, materials with even number of electrons such as carbon and silicon without unpaired spins were not considered seriously in terms of bulk ferromagnetism.

### SUMMARY

Aspects of the present disclosure are related to Q-silicon, Q-carbon and combinations thereof, and synthesis, properties and applications of Q-silicon and Q-carbon. In one aspect, among others, a method comprises forming a layer of amorphous silicon; melting at least a portion of the layer of amorphous silicon in an undercooled state; and forming Q-silicon by quenching the melted amorphous silicon from the undercooled state. In one or more aspects, the layer of amorphous silicon can be formed by irradiation by ions, physical vapor deposition or chemical vapor deposition. The amorphous silicon can be melted by nanosecond laser pulsing. The nanosecond laser pulsing can be at an energy density in a range between about 0.1 J/cm⁻² and about 1.0 J/cm⁻². In various aspects, the Q-silicon can comprise randomly arranged tetrahedra having dangling bonds and unpaired spins between the tetrahedra. The Q-silicon can be amorphous Q-silicon or crystalline Q-silicon based upon a time in the undercooled state. The Q-silicon can be doped with a dopant. The dopant can be p-type (such as boron) or n-type (such as arsenic). Dopant concentrations can exceed a thermodynamic solubility limit of the dopant in silicon.

In another aspect, a Q-silicon comprises a random arrangement of tetrahedra, the tetrahedra comprising dangling bonds, unpaired spins or both, wherein atomic structure of the Q-silicon is based upon time in an undercooled state before quenching. In one or more aspects, the tetrahedra can be doped with a dopant. The dopant can be boron or arsenic in a concentration exceeding a thermodynamic solubility limit of boron in silicon. The atomic structure can be amorphous or crystalline.

In another aspect, a battery anode comprises Q-silicon mixed with a polyvinylidene difluoride (PVDF) binder, the Q-silicon comprising a random arrangement of tetrahedra, the tetrahedra comprising dangling bonds, unpaired spins or both. In various aspects, the battery anode can comprise Q-carbon and the Q-silicon mixed with the PVDF binder. The tetrahedra can be doped with a dopant. The battery anode can comprise a LiF coating formed in a surface of the Q-silicon. The LiF coating can be formed by pulsed laser annealing removing the PVDF binder from top of and between grains of the Q-silicon. The Q-silicon mixed with the PVDF binder can be disposed on a substrate.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A-1F illustrate examples of diamond tetrahedra (D1, D2, D3, D3+), in accordance with various embodiments of the present disclosure.

FIGS. 2A-2D illustrate examples of B-doped Q-silicon (QB1, QB2, QB3), in accordance with various embodiments of the present disclosure.

FIGS. 3A-3D illustrate examples of crystalline Q-silicon, in accordance with various embodiments of the present disclosure.

FIG. 4 is a table showing atom coordinates for B-doped Q-carbon subunit cell and super unit cell, in accordance with various embodiments of the present disclosure. Four common atomic positions between different subunit cells are indicated by C* and common between A and B subunits.

FIGS. 5A-5D illustrate examples of Q-silicon formation, in accordance with various embodiments of the present disclosure.

FIGS. 6A-6D illustrate examples of Raman spectra, in accordance with various embodiments of the present disclosure.

FIG. 7 is a table showing TA (transverse acoustic), LA (longitudinal acoustic), LO (longitudinal optic), and TO (transverse optic) modes and crystalline Si peaks as a function of laser pulse energy density, in accordance with various embodiments of the present disclosure.

FIG. 8 illustrates an example of magnetization (M) vs. field (H) with coercivity for ferromagnetism and diamagnetic behavior before laser annealing, in accordance with various embodiments of the present disclosure.

FIGS. 9A-9C include examples of a micrograph, Raman spectrum, and magnet moment vs. field for Q-carbon, in accordance with various embodiments of the present disclosure.

FIG. 10 illustrates examples of Raman spectra of Q-silicon, in accordance with various embodiments of the present disclosure.

FIG. 11 illustrates an example of magnetic moment (M) vs. field (H) from Q-silicon at 10K, 50K, 100K, 200K, and 300K with diamagnetic behavior before annealing and robust coercivity, in accordance with various embodiments of the present disclosure.

FIGS. 12A and 12B illustrate examples of Q-carbon and Q-silicon anode current capacity, in accordance with various embodiments of the present disclosure.

### DETAILED DESCRIPTION

Disclosed herein are examples related to Q-silicon, Q-carbon and combinations thereof. Reference will now be made in detail to the description of the embodiments as illustrated in the drawings, wherein like reference numbers indicate like parts throughout the several views.

The dangling bonds in bulk carbon and silicon materials usually reconstruct and eliminate sources of unpaired electrons. However, at the free surfaces of covalently bonded materials, steps and kinks can provide sources of dangling bonds and unpaired spins, which can lead to paramagnetism, and ferromagnetism, provided these spins can achieve long-range ordering. A recent discovery showed the occurrence of robust ferromagnetism in Q-carbon comprising randomly packed diamond tetrahedra. The bonding within the tetrahedra in Q-carbon was determined to be sp³ with no dangling bonds. However, the bonding between the tetrahedra was a mixture of sp³ and sp² with overall fraction of about 85% sp³ and 15% sp². Thus, dangling bonds and unpaired spinsbetween the tetrahedra played an important role in producing a robust ferromagnetism in Q-carbon.

The discovery of Q-silicon with atomic density higher than crystalline silicon, while keeping the bonding characteristics the same as normal silicon, is disclosed. Distinct amorphous phases can be created, when one, two or three tetrahedra are randomly packed, and a crystalline phase of Q-silicon is formed, when subunit cells are arranged along <110> directions with alternate holes. Nanosecond laser melting of amorphous silicon in undercooled state and quenching have created Q-silicon with robust ferromagnetism compared to diamagnetism of silicon. The Curie temperature of Q-silicon is estimated to be over 400K, thus opening a new frontier for spin-based computing and atomic-level storage.

The formation of Q-silicon after nanosecond laser melting of amorphous silicon layers and quenching from the undercooled state is reported. The amorphous silicon produced by ion implantation showed a diamagnetic behavior, which turned ferromagnetic upon laser annealing. It is interesting to note that as-implanted amorphous silicon and Q-silicon both involve random arrangement of tetrahedra, however, the number density of these tetrahedra in the Q-silicon is considerably higher than in the ion implanted amorphous silicon. In ion implanted silicon, there is 100% sp³ bonding and dangling bonds between the tetrahedra are saturated with no unpaired spins. The details of atomic structure of the Q-silicon phases and the phenomenon polyamorphism related to distinct amorphous phases of Q-silicon are discussed. The unpaired spins in amorphous Q-silicon, comprising randomly packed tetrahedra, can have dangling bonds and unpaired spins between the tetrahedra, where these spins provide the source for bulk paramagnetism and ordered ferromagnetism, as shown for Q-carbon. It should be mentioned that dopants such as boron can eliminate unpaired spins and the ferromagnetism associated with them, and lead to high-temperature superconductivity, as elegantly demonstrated in highly B-doped Q-carbon.

### Atomic Structure and Design of Amorphous Q-Phases

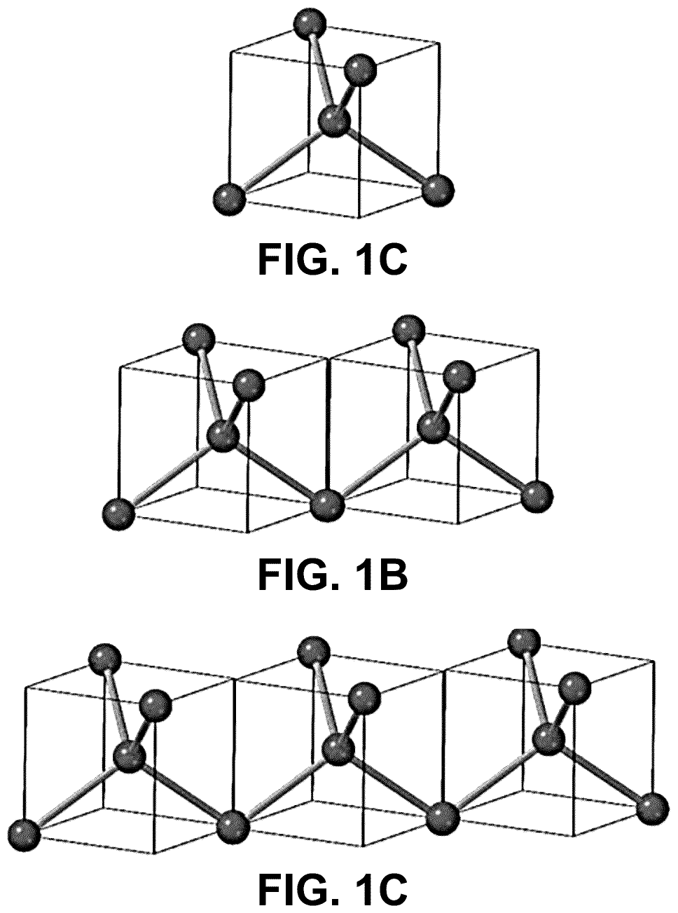

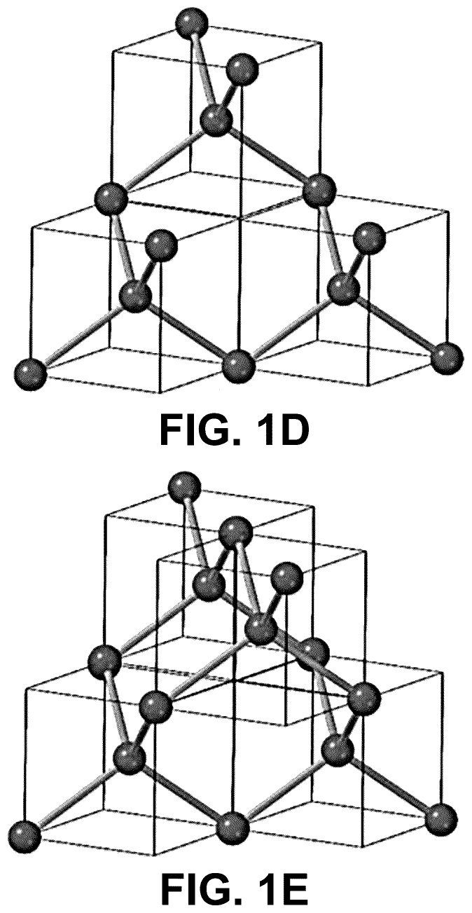

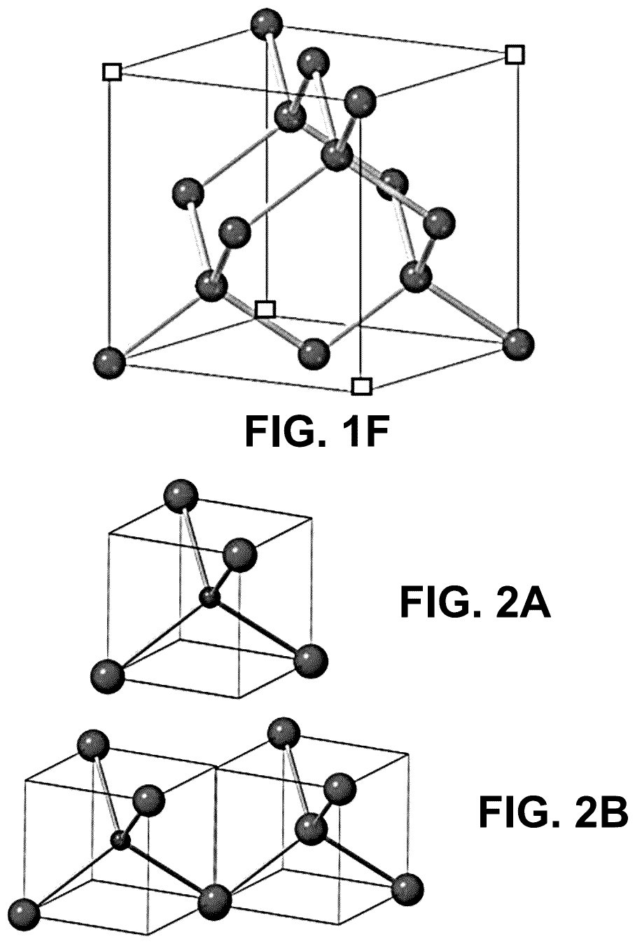

The basic building block in both amorphous and crystalline Q-phases is a silicon/diamond cubic tetrahedron. FIG. 1A graphically illustrates an example of a diamond tetrahedron D1 with a central atom contained in a (a/2, a/2, a/2) cube. This tetrahedron (D1) is contained in one-eighth of the diamond cubic unit cell. The tetrahedron consists of two triangular units, which are arranged in perpendicular <110> and <1-10> directions. These triangular units, which are bonded in <111> directions, represent basic characteristics of covalent bonding.

These tetrahedra can grow along the <110> direction. FIG. 1B illustrates two tetrahedra (D2) connected along <110>. FIG. 1C shows three tetrahedra (D3) connected along the <110> direction. It should be noted that these tetrahedra are joined along the <001> axis, around which they can pivot and form a long ring or a string structure. These ring and string structures can play a role in enhancing the mobility of carriers. If the third tetrahedron joins along <1-10> instead of <110> in the second plane, three D1 tetrahedra form a D3+ with two in the <110> direction (first layer) and one in the <1-10> direction (second layer), as shown in FIG. 1D. It is interesting to note that D3+ is precursor to diamond cubic unit cell.

When a fourth tetrahedron joins along the <1-10> direction in the second plane, it becomes silicon/diamond cubic unit cell, as shown in FIG. 1E. This is the diamond unit cell missing four neighboring tetrahedral. Here all the atoms are tetrahedrally bonded by four atoms, which leaves a net of eight atoms in the unit cell. The silicon cubic unit cell, as shown in FIG. 1F, has four corner atoms, which are shared by four atoms with a net of one atom. If the corner atoms are shared by eight unit cells, then it has a net one atom. With these building blocks (D1, D2, D3, and D3+), new phases can be created, named Q-phases of silicon, which are in parallel to distinct Q-phases of carbon and BN, namely, Q1, Q2, and Q3. These Q-phases are expected in all the materials of zinc blende structures with higher number density of atoms than diamond cubic unit cell, and exhibit novel properties.

### Formation and Doping of Amorphous Q-silicon

When D1, D2, and D3 and D3+ tetrahedral units are packed randomly, Q3, Q2, and Q1 phases of Q-silicon can be created. It has been shown through geometrical and theoretical modeling that tetrahedral units can be packed randomly with a packing efficiency of ≥80%. However, packing of diamond tetrahedra with covalent dangling bonds at the surfaces may pose additional constraints. These distinct phases represent three allotropes of Q-silicon and the phenomenon of polyamorphism in silicon. By replacing one the silicon by boron, for example the central atom in the tetrahedron, B-doped Q-silicon can be created with dopant concentrations far exceeding the thermodynamic solubility limit.

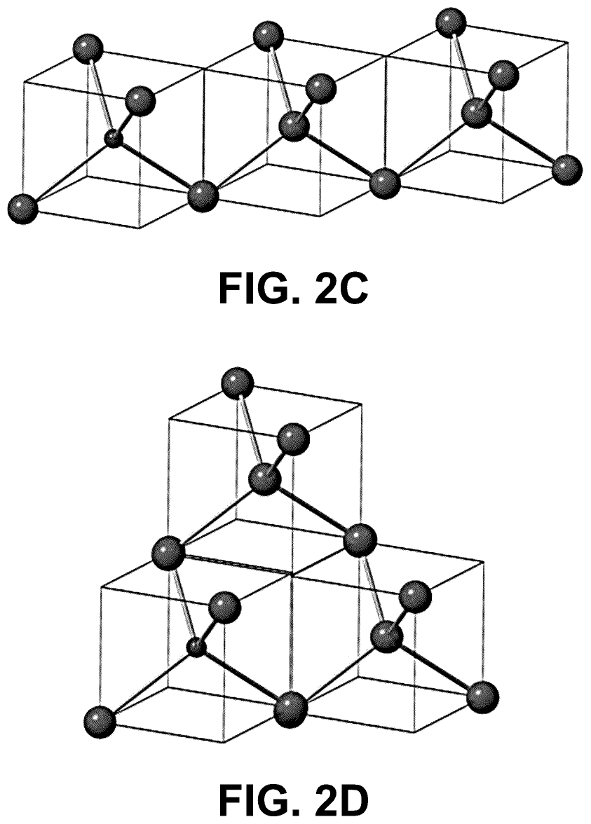

FIG. 2A illustrates an example of the formation of QB3, when one central C atom is replaced by B in a single tetrahedron. By replacing the central atom in the D1 tetrahedron by boron and packing randomly, 50 at % B-doped Q-silicon (QB3 silicon) can be created. FIG. 2B illustrates an example of the formation of QB2, when one central C atom is replaced by B in a two-unit (drimer) tetrahedra. By replacing the central atom by boron in one of the two tetrahedra in D2 and packing randomly, 25 at % B-doped Q-silicon (QB2 silicon) can be created. FIG. 2C illustrates an example of the formation of QB1, when one central C atom is replaced by B in a three-unit (trimer) tetrahedra. Similarly, by replacing the central atom by boron in one of the three tetrahedra in D3+ and packing randomly, 17 at % B-doped Q-silicon (QB1 silicon) can be created. FIG. 2D illustrates this example of formation of QB1 with D3+.

These allotropes of silicon may have different electrical, optical, and mechanical properties, as demonstrated by robust ferromagnetism in undoped Q-carbon and record BCS superconducting properties of B-doped Q-carbon, where QB1, QB2, and QB3 showed Tc of 37K, 57K, and >250K, respectively. There may be issues related to lattice strain. As boron enters substitutional sites in the diamond crystalline lattice, it may generate unwanted tensile strain (covalent radius of B=0.082 nm; and covalent radius of silicon=0.117 nm), which could lead to disorder scattering and breaking up of the Cooper pairs. Issues related to dopant misfit strains in amorphous structures will be considerably less than in crystalline counterparts.

### Formation and Doping of Crystalline Q-Silicon

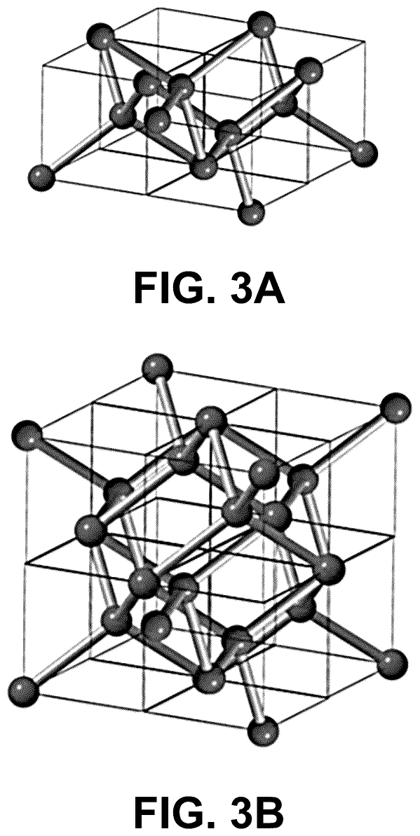

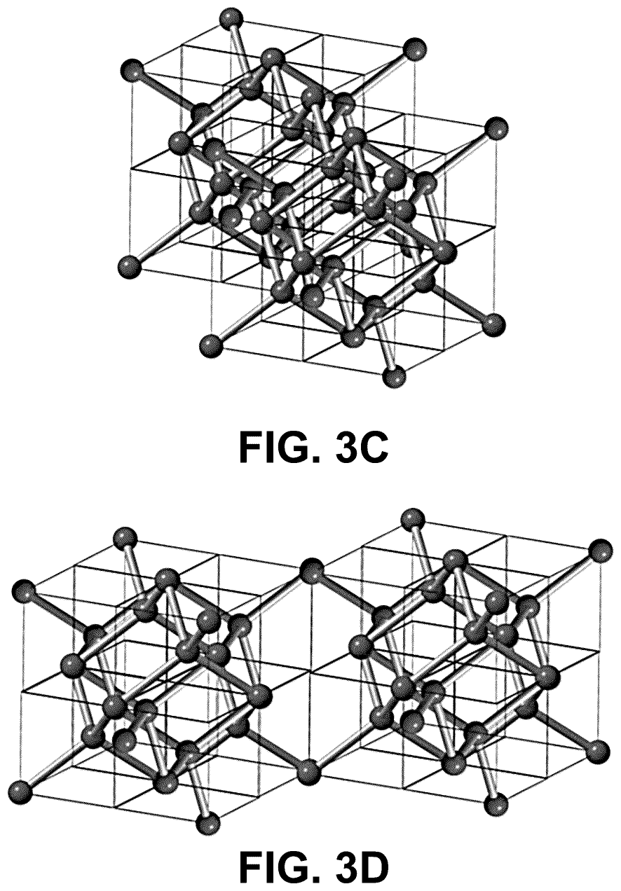

When four D1 tetrahedra get together in one plane, the basic unit cell (D14) can be created for the formation of crystalline Q-silicon, as shown in FIG. 3A. By adding another four tetrahedra in a second plane, a Q-silicon subunit cell can be created. FIG. 3B illustrates eight tetrahedra in two planes, leading to formation of the Q-diamond subunit cell with net 16 atoms. These subunit cells can grow only along <110> direction, as the face atoms are already saturated with four covalent bonds. When third subunit cell joins in the <1-10> direction in the second plane, a precursor to crystalline Q-silicon super unit cell will have been created. This super unit cell for crystalline Q-silicon is completed by putting fourth subunit cell in <1-10> direction in the second plane. FIG. 3C illustrates formation of Q-diamond super unit cell with four subunit cells: two in <110> direction and two in <1-10> direction. FIG. 3D shows the Q-diamond super unit cell with missing four neighboring subunit cells, similar to missing tetrahedra in the diamond unit cell. By replacing central C atoms in these tetrahedra by B atoms selectively, 50% B-doped Q-diamond phase is created, having net 32 C and 32 B atoms arranged in two layers.

The super unit cell contains net 64 atoms with a lattice constant of 1.086 nm. Thus, while the number density of the subunit cell locally is 16/a³, the average number density for the super unit cell is 8a³, which is the same as the cubic diamond unit cell. Thus, by replacing the tetrahedra by the subunit cell with both having number density of 16/a³, the Q-silicon structure can be achieved. This is a very interesting parallel between diamond cubic lattice and Q-silicon lattice, where local structures having double the number density of atoms alternate with empty spaces for a net half the number density of atoms.

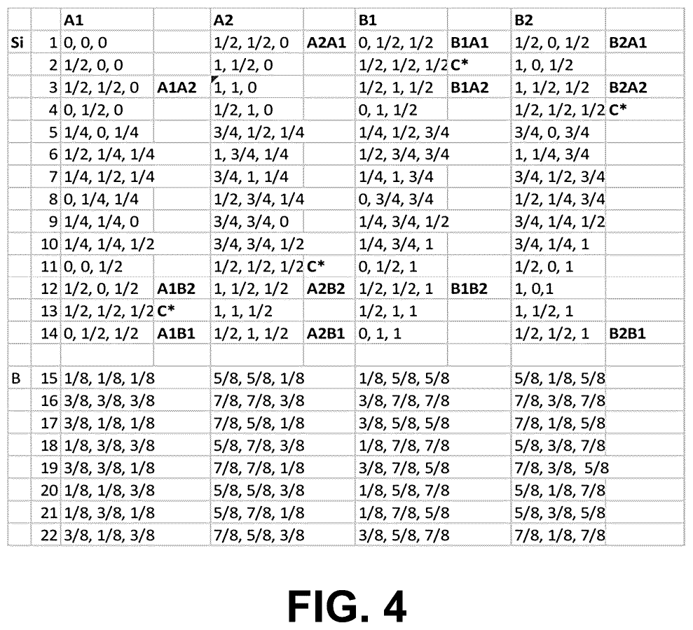

The table of FIG. 4 shows coordinates of atoms in all the four subunits (A1, A2, B1, B2) of a super unit cell. There are 22 atoms (8 corners+6 faces+8 inside) in each subunit with one common (C*) to all, and three other atoms between two subunits, leaving 79 distinct atomic positions. In the table of FIG. 4, rows of atoms 1 through 14 represent corner and face atoms, and rows 15 through 22 are the 8 inside atoms. For doping purposes, the rows of inside atoms can be replaced by dopants with each row accounting for 6.25 at %. The replacement of two rows 15 and 16 leads to 12.5 at % B-doped Q-silicon. For boron doping of silicon, this is far higher than the thermodynamic solubility limit of 1.2 at % of B in silicon. To achieve these higher dopant concentrations, highly nonequilibrium methods were adopted to kinetically trap the dopants in higher energy states by nanosecond laser melting and quenching. It has been shown that low-energy ion implantation of amorphous carbon can lead to Q-carbon conversion over a large-area with a wafer-scale integration.

### Experimental Details

The Si (100) and Si (111) substrates about 40 μm thick were irradiated with 100 keV Ge⁺ and As⁺ ions to a dose of 1.0×10¹⁶ ions·cm⁻², which amorphized crystalline silicon to a depth of about 170 nm. Pulsed laser annealing was carried out using ArF excimer laser (193 nm wavelength, and 20 ns pulse duration) with energy density varied between 0.1 and 0.3 J/cm⁻². Microstructure and atomic structure determinations of Q-silicon were carried out by using high-resolution scanning electron microscopy (HRSEM), electron backscatter diffraction (EBSD), and (scanning) transmission electron microscopy (STEM and TEM). The bonding characteristics were determined by core-loss EELS and Raman spectroscopy. HRSEM studies were performed using secondary and backscattered electrons (having a sub-nanometer resolution) in a FEI Verios 460L SEM. The TEM/STEM cross-section samples were prepared by FIB milling using ThermoFisher Quanta 3D FEG microscope. The aberration-corrected STEM-ThermoFisher Titan 80-300 was used to perform the (scanning) transmission electron microscopy. The EELS scans were performed by using the EELS detector mounted in the STEM-ThermoFisher Titan 80-300 microscope. The Raman measurements were made using an Alfa300 R superior confocal Raman spectroscope (lateral resolution <200 nm) having 532 nm excitation source. The Raman spectrometer was calibrated using a standard crystalline Si sample with a vibrational mode (Raman peak) at 520.6 cm⁻¹. Magnetic measurements were performed in magnetic fields up to 1 T in an Ever Cool Quantum Design PPMS system with a base temperature as low as 10 K.

### Experimental Results

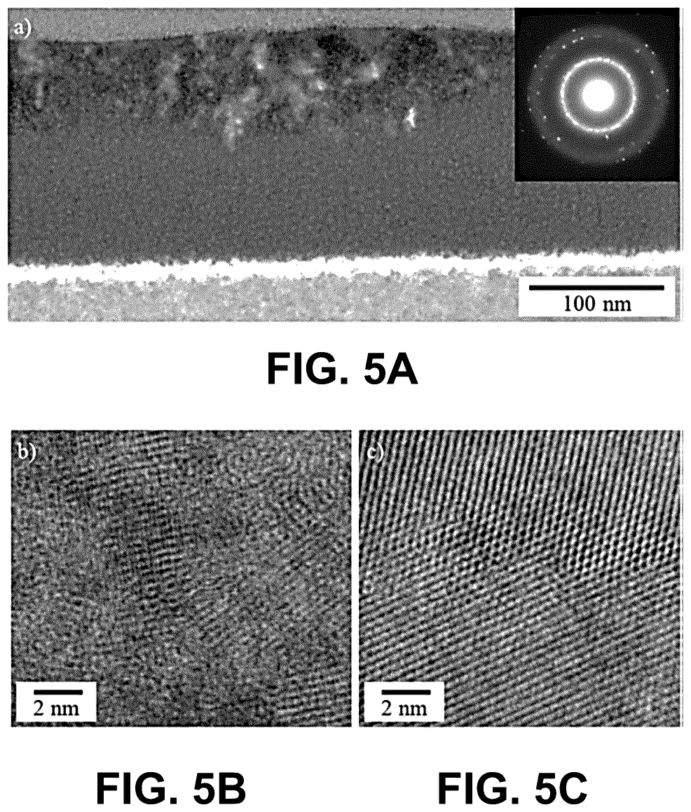

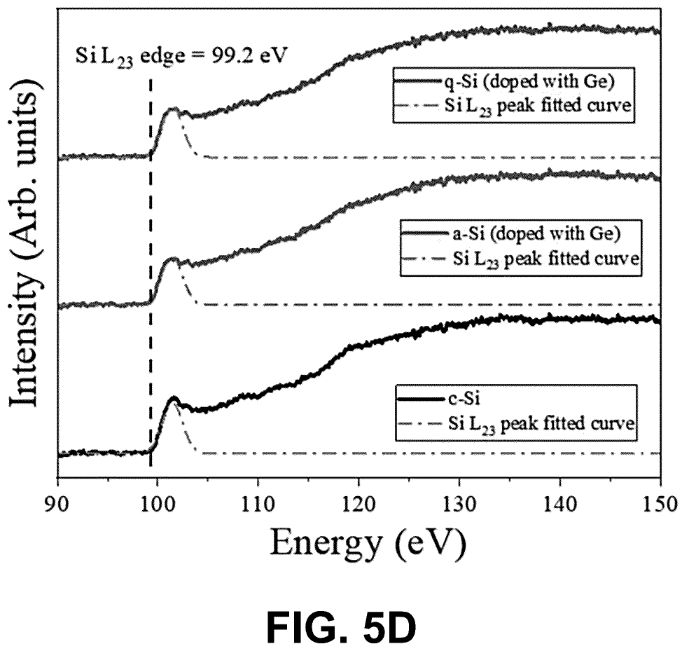

By nanosecond laser melting of amorphous silicon and rapid quenching from the highly undercooled state, amorphous and crystalline Q-silicon can be created. The molten silicon is metallic, where electrons are delocalized and atoms closely packed. In the undercooled state, electrons start to delocalize and form diamond tetrahedra with covalent bonds. Depending upon the time available in the undercooled state, amorphous Q-silicon, crystalline Q-silicon, or zinc blende silicon can form with increasing time. FIGS. 5A-5C are high-resolution TEM micrographs showing formation of Q-silicon. FIG. 5A shows a <110> cross-section TEM with 85±5 nm Q-silicon layer and inset diffraction pattern; FIG. 5B shows an Interface between Q-silicon and amorphous silicon; and FIG. 5C shows nanocrystallites in Q-silicon with nanotwins.

The cross-section TEM micrograph in FIG. 5A shows the formation of the Q-silicon band that is 85±5 nm wide for 0.3 Jcm⁻² sample, which is followed by the amorphous silicon layer that is 85±5 nm wide created by Get ion implantation. The selected-area diffraction pattern (shown in the inset) shows (111) and (200) diffraction rings, in addition to diffused rings from amorphous zinc blende and Q-silicon The crystalline Q-silicon shows (200) diffraction spots (inset), which are missing in normal cubic zinc blende structure, as shown by structure factor calculations of Q-phases. The new Q-phase structure has 3 Si atoms (Si₀ (0,0,0), Si₁ (1/4,1/4,1/4) and Si₂ (1/4,1/4,3.4)) forming the basis for the FCC lattice instead of two Si atoms in Diamond Cubic phase (Si₀ and Si₁ only). The structure factor of DC-Si is

$${F}_{DC - Si} = {f}_{Si} [ 1 + {e}^{\frac{π ( h + k + l )}{2}} ] [ 1 + {e}^{\frac{π ( h + k )}{2}} + {e}^{\frac{π ( k + l )}{2}} + {e}^{\frac{π ( h + k )}{2}} ]$$

whereas structure of Q-Si is

$${F}_{Q - Si} = {f}_{Si} [ 1 + {e}^{\frac{π ( h + k + l )}{2}} + {e}^{\frac{π ( h + k + 3 l )}{2}} ] [ 1 + {e}^{\frac{π ( h + k )}{2}} + {e}^{\frac{π ( k + l )}{2}} + {e}^{\frac{π ( h + k )}{2}} ] .$$

For a [011̅] zone axis, it allows presence of (200) planes [┌F_{Q-Si}┐=16f_{Si}²], which was not possible in diamond cubic structures (┌F_{DC-Si}┐²=0).

FIG. 5C shows high-resolution TEM of an interface between Q-silicon and amorphous silicon. The amorphous Q-silicon contains nanocrystallites of zinc blende silicon (FIG. 5B). Some of the nanocrystallites contain nanotwins as result of rapid quenching, as shown in FIG. 5C. FIG. 5D shows EELS spectra from crystalline silicon (c-Si), Ge+ ion implanted amorphous silicon (a-Si), and Q-silicon (Q-Si). The Si L23 edge structures at 99.2 eV in all three cases remain the same (unchanged), indicating 100% sp³ bonding in all three cases.

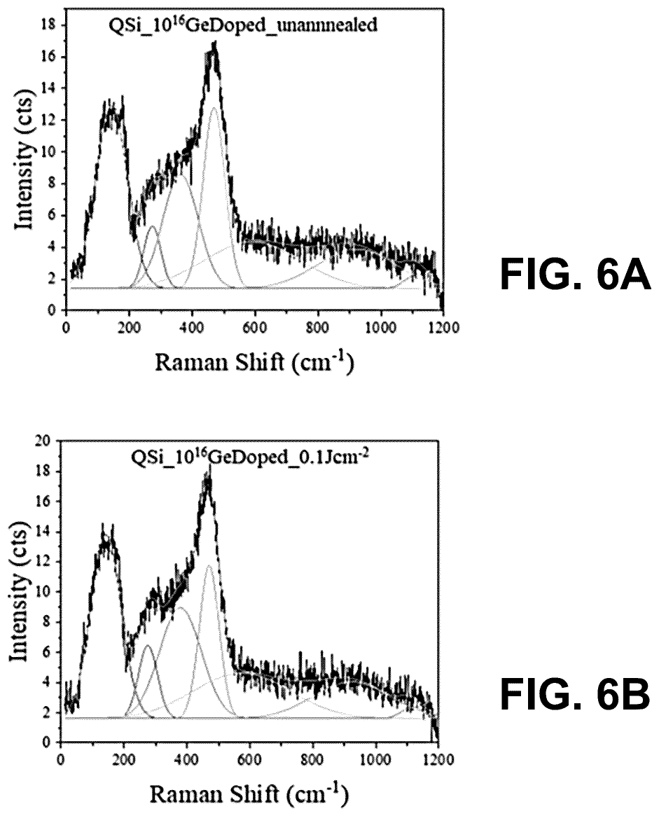

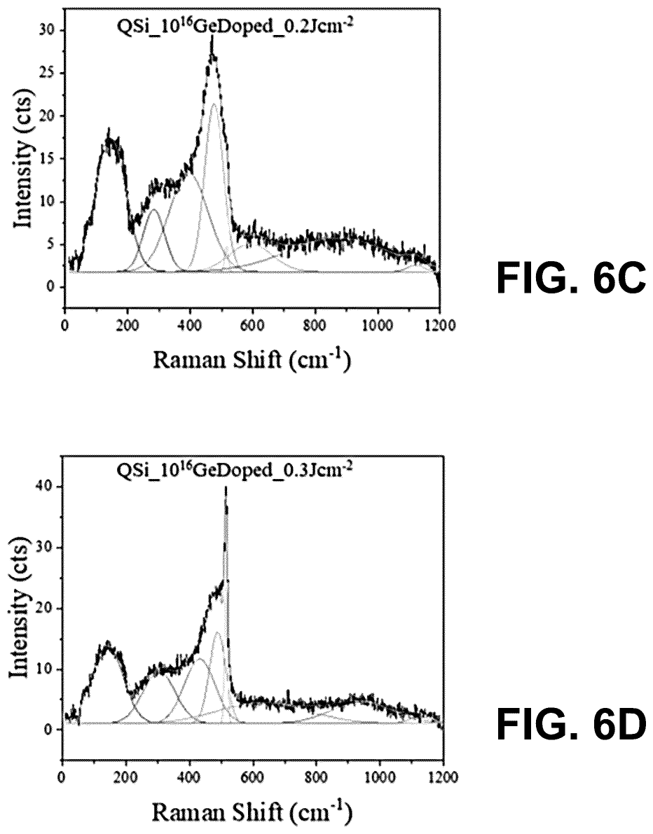

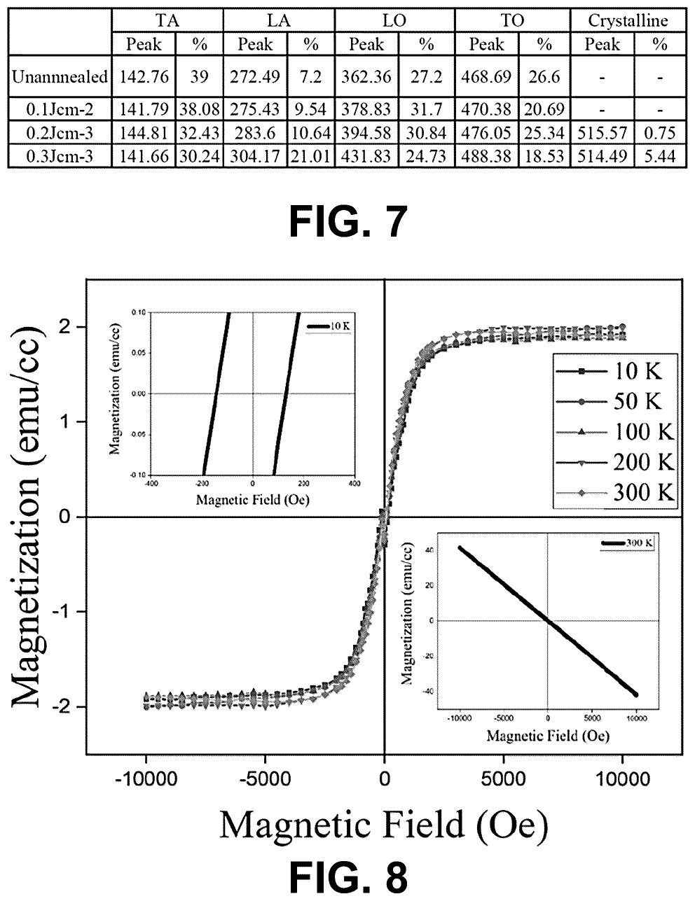

FIGS. 6A-6D show results from Raman spectroscopy of amorphous silicon before laser annealing (FIG. 6A) and after laser annealing with 0.1 Jcm⁻², 0.2 Jcm⁻², and 0.3 Jcm⁻² in FIGS. 6B, 6C and 6D, respectively. The Raman spectra contain TA (transverse acoustic), LA (longitudinal acoustic), LO (longitudinal optic), and TO (transverse optic) modes. The table of FIG. 7 shows a detailed analysis of variation of these modes and crystalline Si peaks as a function of laser pulse energy density. As the pulse energy density increases TO mode frequency increases, which is indicative of increasing bond energy in laser annealed Q-silicon. The structure of Q-silicon after annealing with 0.1 Jcm⁻² pulse is totally amorphous, however, the crystalline fraction appears after 0.2 Jcm⁻² and increases at 0.3 Jcm⁻². This is indicative of the fact that as the energy density increases, melt lifetime increases and more time is available for crystal growth. These results are consistent with detailed cross-section TEM results. The crystalline silicon nucleates from the undercooled molten silicon and size of nanocrystallites depends upon the time available for crystal growth. It is interesting to note that nanocrystalline peaks are downshifted from 520.6 cm⁻¹ to 515 cm⁻¹ due to quantum confinement effects.

FIG. 8 is a curve illustrating magnetization (M) versus field (H) at 10K, 50K, 100K, 200K and 300K of 0.3 Jcm⁻² sample with a first inset (top left) showing coercivity for ferromagnetism, and a second inset (bottom right) showing diamagnetic behavior before laser annealing. FIG. 8 shows that ion-implanted (100 KeV As⁺ with a dose=1.0×10¹⁶ cm⁻²) is diamagnetic, as indicated in the inset. Interestingly, M vs H plot shows a robust ferromagnetic behavior with an estimated Curie temperature above 500K, after nanosecond laser annealing (ArF Excimer laser with 193 nm wavelength, and pulse duration 20 ns) with pulse energy density in the range 0.1 to 0.3 Jcm⁻². The laser annealed silicon exhibits finite coercivity (inset), characteristic of long-range ferromagnetic ordering, as shown for the 0.3 Jcm⁻² sample. Amorphous silicon before laser annealing shows a diamagnetic behavior, where silicon dangling bonds between tetrahedra are saturated. The tetrahedra in as-implanted amorphous silicon are not as closely packed as in Q-silicon, and sp³ dangling bonds find their way to reconstruct. On the other hand, in amorphous Q-silicon, the tetrahedra are closely packed, leaving dangling bonds between them. In addition, the dangling bonds at the interface between the amorphous and nanocrystalline regions can lead to dangling bonds.

Atomic structures of amorphous and crystalline Q-silicon, which can include dopant concentrations far exceeding the thermodynamic solubility limits through solute trapping phenomenon, have been presented. The basic unit of Q-phases is diamond tetrahedron with atomic number density of 16/a³. By packing them randomly with the units of one, two, and three tetrahedra, distinct phases Q3, Q2, and Q1 of silicon can be created, which have much higher number density (>60%) of atoms than that of cubic zinc blende structure. The cubic zinc blende structure of silicon is formed by putting two tetrahedra in <110> direction followed by two in <1-10> in next plane. This leaves alternate empty spaces and explains the lower density of atoms 8/a³ in cubic zinc blende structure with atomic packing fraction of only 34%. Thus, three tetrahedra in two adjacent planes are precursor to cubic unit cell.

By putting together eight tetrahedral without empty spaces, subunit cell can be created for crystalline Q-silicon with sixteen atoms, having eight inside, six face atoms, and eight corner atoms. This is similar to a calcium fluoride structure. However, in this case with covalent bonding, face atoms are already coordinated with four atoms. As a result, to form a three dimensional crystalline structure, these subunit cells are arranged two in <110> and two in <1-10> directions to form a super unit cell of sixty atoms, as shown in the table of FIG. 4. This arrangement leaves alternate empty spaces, similar to the tetrahedral arrangement in the cubic lattice. While subunit cells have number density of atoms of 16/a³, the super unit cell has only 8/a³. By replacing Si atoms by dopants, Q-phases can be doped with distinct concentrations far higher than thermodynamic dopant solubility limits. The Q-phases can accommodate dopant size misfit induced strains more effectively and lead to less carrier scattering. It was found that amorphous Q-silicon can have dangling bonds and unpaired spins between the tetrahedra, which provide the source for bulk paramagnetism and ordered ferromagnetism.

Dangling bonds in covalently silicon-based materials can provide a source for paramagnetism and ordered ferromagnetism. Nevertheless, the dangling bonds in the bulk of these materials reconstruct to eliminate sources for paramagnetism and ferromagnetism. However, unreconstructed dangling bonds on surfaces, steps and kinks can provide sources of electron spins with atomic-scale paramagnetism and ferromagnetism. B-doped Q-silicon phases have also been shown to be superconducting as a result of higher number density of states near the Fermi level, and an optimum combination of phonon hardening within tetrahedra and phonon softening because of alternate empty spaces. Theoretical results for 12.5 at % B-doped crystalline Q-silicon show frequency (RMS) average as @ph=300-400 cm⁻¹, and cut-off frequency Ω=1000 cm⁻¹. From these values, the superconducting transition temperature (T_{c}) estimated as T_{c}=174K, 171K, and 167K for ωₚₕ=300 cm⁻¹, 350 cm⁻¹, and 400 cm⁻¹, respectively.

### Q-Carbon and Q-Silicon Anodes to Create High Performance Batteries

Due to the rapid increase in the energy demands for consumer electronics and rise in the global warming along with excessive environmental pollution, a lot of attention has been paid to the energy conversion storage devices like solar cells, supercapacitors, and batteries. In this scenario, energy conversion and energy storage are the two prime key technologies to cope with the existing energy crisis. Therefore, batteries have been prime target of research for their potential use in portable devices and electric vehicles. Lithium-ion batteries (LIBs) have revolutionized portable electronics in the last three decades, as they are able to deliver higher energy per unit volume or mass than other rechargeable battery systems and have better reversible capacity, no hysteresis, and long cycle stability. However, further improvements in energy density can make a similar impact on transportation and stationary storage of renewable energy from sources like wind and solar. The higher energy can be derived from higher cell voltage and current capacity, both of which depend upon materials chemistry and microstructural characteristics of cathode and anode materials of LIBs.

According to the LIB history and electrochemical performance, carbon-based materials can play important roles for energy storage. The most widely used LIB anode material is currently graphite, where graphite flakes (10-20 μm) are bound together using a PVDF (polyvinylidene difluoride) conducting binder. These graphite anodes have limited current capacity (372 mAh/g) with a drawback of lithium plating due to its operating voltage close that of Li/Li⁺ and short circuiting by the formation of lithium dendrites.

Silicon-based anode materials have high current capacity, but have a drawback related to high volume expansion and cracking during lithiation (charge) and delithiation (discharge) cycles in large-grain materials. Inducing defects in the lower dimensionality of the graphite anode can be helpful in achieving higher capacity rates. Reducing the electrode particle size and increasing the surface to volume ratio has also been proven to enhance the electrochemical dynamics and battery performance. In graphite-based anodes, various modification methods have been applied in graphite preparation, for enhancing the electrochemical performance in the LIBs. However, there was no improvement in the lithium diffusion rate in graphite particles. Since the lithium ions intercalate-deintercalate from the edges of graphite layers, the larger the graphite crystals are, the slower the lithium ions intercalate-deintercalate into/from the graphite.

The graphite (0001) sheets have covalent σ bonding in the plane and π bonding normal to the sheets. These π bonds are delocalized, providing the source for conductivity in graphite along the sheets. These free π electrons can be trapped by Li⁺ during charging to form Li⁰ and promote lithium clustering and plating, which reduces current capacities. By saturating these π bonds with hydrogen and fluorine can delay and avoid the lithium-ion plating. Annealing is another powerful method to improve the microstructure of the films. Most of the previous studies on laser processing of electrodes focused on surface restructuring by rapid melting and evaporation. The primary aim was to increase the surface area for Li⁺ ion charging by creating channels and grooves on cathode surfaces. However, rapid melting and quenching can result in formation of undesirable phases, which may lead to reduced cell energy density.

A film of Q-carbon and Q-silicon mixed with polyvinylidene difluoride binder solution (PVDF) on a copper substrate was used as a reference anode material. It was characterized by scanning electron micrograph (SEM), Raman, X-ray Diffraction (XRD) for structure and surface morphology. Atomic force microscopy (AFM) and Keyence laser profiling were done to see the sample roughness. EDS was done to check for any impurities. These samples were then annealed using nanosecond ArF excimer laser (wavelength=193 nm, pulse duration=20 ns) at different laser energy densities. The parameters of laser pulse and energy density were optimized, and 0.7 J/cm² energy density to anneal the samples. These samples were irradiated with 10 and 80 pulses of 0.7 J/cm² energy density ArF excimer laser. There was a significant change in the morphologies observed after 10 and 80 shots samples compared to the reference samples.

These samples were characterized by WITec confocal Raman microscope system (532 nm laser source) with a grating size of 1800 I/mm for Raman-active vibrational modes in as-deposited and laser annealed samples. The Raman intensities were calibrated by making sure that the zero-loss peak was accurately observed at zero, and there is peak at 520 cm⁻¹. The XRD 20 scans were performed using a Rigaku SmartLab X-ray diffractometer brag diffraction operating mode, using a Cu-Ka radiation source from a sealed tube operating at a voltage and current of 40 kV and 25 mA, respectively, and state of the art LENXEYE XE detector. HR-SEM and energy dispersive X-ray spectrometers (EDS) for surface morphology and elemental analysis, respectively, were performed using FEI Verios 460L SEM.

State of the art Keyence VKx1100, a Confocal Laser Scanning Microscope (CLSM) which combines optical microscopy with laser profilometry to obtain high resolution optical images was used to measure surface morphology and microstructure of reference and laser annealed samples. X-ray photoelectron spectroscopy (XPS) data were acquired using an Axis Ultra XPS system (Kratos Analytical, Spring Valley, NY, USA); the instrument contains monochromatic Al-Kα (1.487 keV) as the X-ray excitation source. For the survey scan, a pass energy of 160 eV was utilized; for the region scan, a pass energy of 20 eV was used. All of the data were calibrated to the C-C peak at 284.8 eV.

Electrochemical testing was done using half cells against carbon electrode. The electrolyte was a solution of 1 M NaClO4 in ethylene carbonate (EC) and diethyl carbonate (DEC) (1:1 in vol). Coin cells (CR2032) comprising the tire-derived carbon electrode, glass fiber, and electrolyte were assembled in an Ar-filled glove box. Galvanostatic charge/discharge was carried out on a Land CT2001 battery test system (Wuhan, China) at current density of 20 mAg-1 at room temperature. The sodiated electrodes were disassembled in an Ar-filled glovebox.

The basic unit of Q-phases (Q-carbon and Q-silicon) is diamond tetrahedron with atomic number density of 16/a³. By packing them randomly with the units of one, two, and three tetrahedra, distinct phases Q3, Q2, and Q1 of carbon and silicon can be created, which have a much higher number density (>60%) of atoms than that of cubic zinc blende structure. The cubic zinc blende structure of diamond and silicon is formed by putting two tetrahedra in <110> direction followed by two in <1-10> in next plane. This leaves alternate empty spaces and explains the lower density of atoms 8/a³ in cubic zinc blende structure with an atomic packing fraction of only 34%. Thus, three tetrahedra in two adjacent planes are a precursor to cubic unit cell diamond and crystalline zinc blende silicon.

By putting together eight tetrahedral without empty spaces, a subunit cell can be created for crystalline Q-carbon or Q-silicon with sixteen atoms, having eight inside, six face atoms, and eight corner atoms. This is similar to calcium fluoride structure. However, in this case with covalent bonding, face atoms are already coordinated with four atoms. As a result, to form a three-dimensional crystalline structure, these subunit cells are arranged two in <110> and two in <1-10> directions to form a super unit cell of sixty atoms, as shown in the table of FIG. 7. This arrangement leaves alternate empty spaces, similar to tetrahedral arrangement in the cubic lattice. While subunit cells have a number density of atoms of 16/a³, the super unit cell has only 8/a³.

By replacing Si atoms by dopants, Q-phases can be doped with distinct concentrations far higher than thermodynamic dopant solubility limits. The Q-phases can accommodate dopant size misfit induced strains more effectively and lead to less carrier scattering. Amorphous Q-carbon and Q-silicon can have dangling bonds and unpaired spins between the tetrahedra, which provide the source for bulk paramagnetism and ordered ferromagnetism. Dangling bonds in covalently carbon and silicon materials can provide a source for paramagnetism and ordered ferromagnetism. Nevertheless, the dangling bonds in the bulk of these materials reconstruct to eliminate sources for paramagnetism and ferromagnetism. However, unreconstructed dangling bonds on surfaces, steps and kinks can provide sources of electron spins with atomic-scale paramagnetism.

Q-carbon, Q-silicon, and mixture of Q-carbon and Q-silicon can be used as anode materials with standard NMC 811 and LMNO as cathode materials. These results are compared with standard macrocrystalline graphite materials, which are rated for a maximum theoretical current capacity of 372 mAh/g. Both Q-carbon and Q-silicon show ferromagnetism.

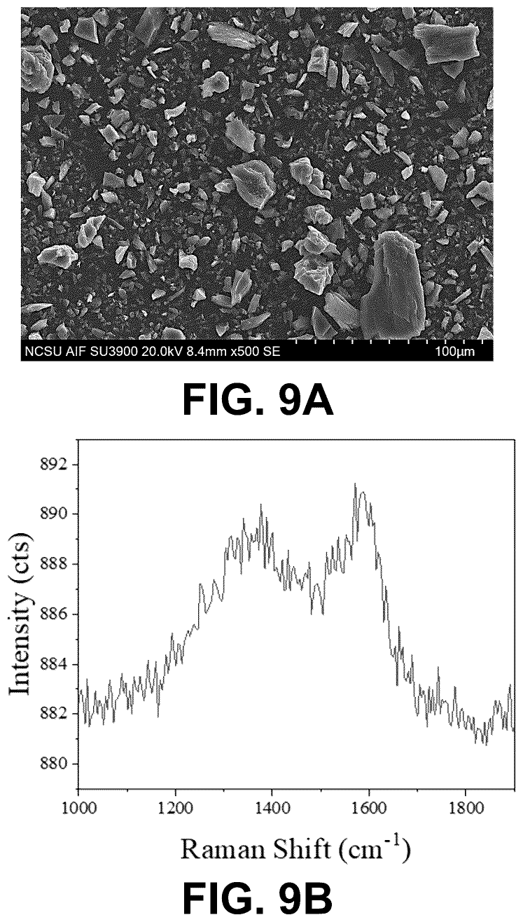

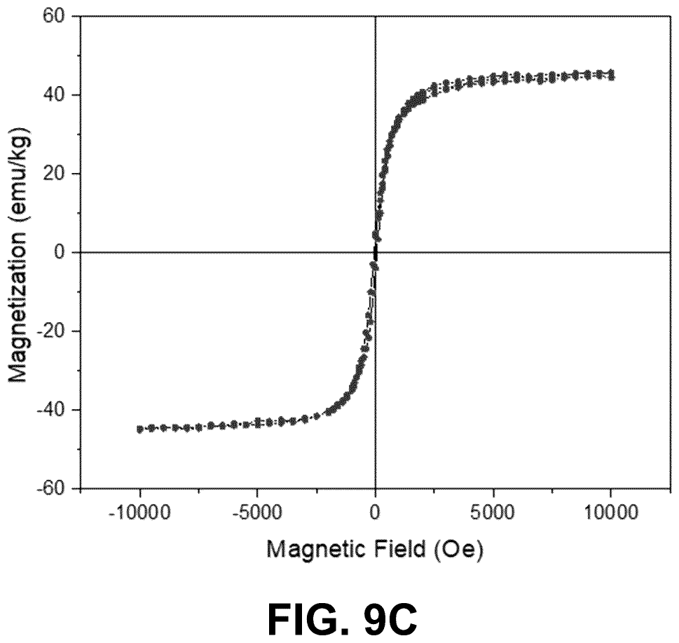

FIG. 9A shows a high-resolution optical micrograph for Q-carbon with grain size ranging from nanometers to micrometers 1 nm to 1000 nm. The Raman spectrum in FIG. 9B provides characteristic Raman double humps at 1350 cm⁻¹ and 1550 cm⁻¹. The magnetic measurements showed a robust ferromagnetism at room temperature with Currie temperature above 600K. FIG. 9C illustrates magnetic moment vs. field with insert at higher magnification showing robust coercivity values.

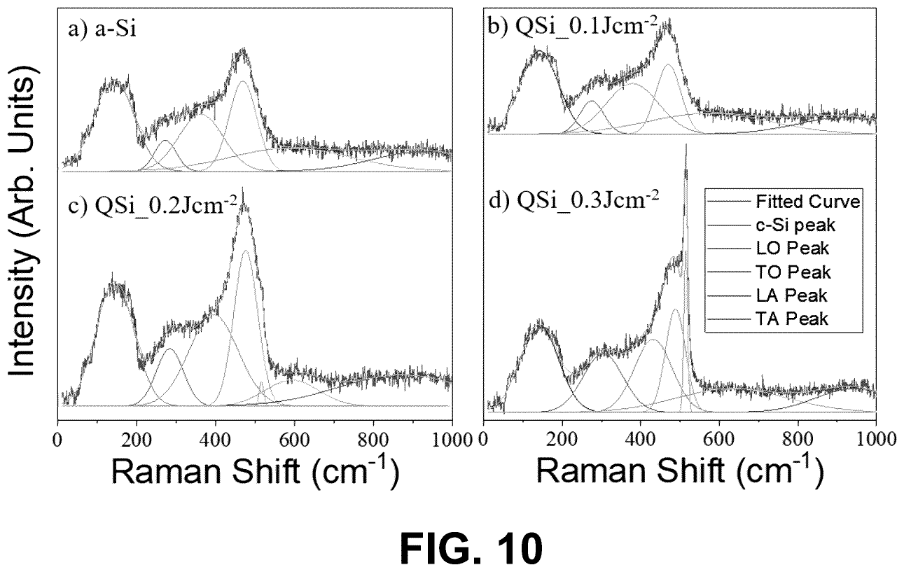

FIG. 10 shows results from Raman spectroscopy of amorphous silicon before laser annealing (plot (a) on upper left) and after laser annealing with 0.1 Jcm⁻², 0.2 Jcm⁻², and 0.3 Jcm⁻² in FIG. 10 (plots (b), (c) and (d), respectively). The Raman spectra contain TA (transverse acoustic), LA (longitudinal acoustic), LO (longitudinal optic), and TO (transverse optic) modes. The table of FIG. 7 shows a detailed analysis of variation of these modes and crystalline Si peaks as a function of laser pulse energy density. As the pulse energy density increases TO mode frequency increases, which is indicative of increasing bond energy in laser annealed Q-silicon. The structure of Q-silicon after annealing with 0.1 Jcm⁻² pulse is totally amorphous, however, the crystalline fraction appears after 0.2 Jcm⁻² and increases at 0.3 Jcm⁻². This is indicative of the fact that as the energy density increases, melt lifetime increases and more time is available for crystal growth. These results are consistent with detailed cross-section TEM results. The crystalline silicon nucleates from the undercooled molten silicon and size of nanocrystallites depends upon the time available for crystal growth. Nanocrystalline peaks are downshifted from 520.6 cm⁻¹ to 515 cm⁻¹ due to quantum confinement effects.

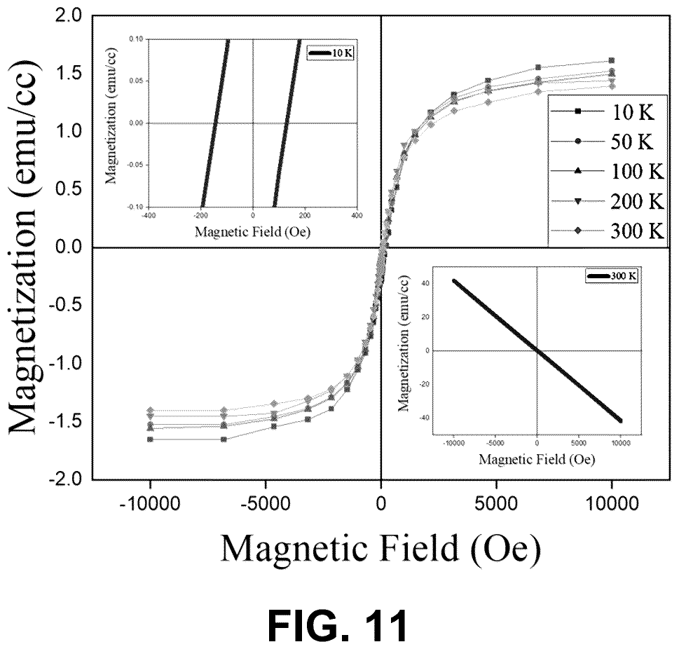

FIG. 11 includes a plot of magnetic moment (M) versus field (H) plot from Q-silicon at 10K, 50K, 100K, 200K, and 300K. The bottom right inset of FIG. 11 shows that amorphous silicon is diamagnetic. Interestingly, the M vs H plot shows a robust ferromagnetic behavior at 10K, 50K, 100K, 200K, and 300K. From saturation magnetization as a function, Curie temperature was estimated above 600K using the Block formula. The blocking temperature from M vs T plots has been estimated to be greater than 400K. These measurements were carried out for the sample annealed at 0.3 Jcm⁻² (ArF Excimer laser with 193 nm wavelength, and pulse duration 20 ns). The laser annealed silicon exhibits finite coercivity of 100 Oe (intercept along the x-axis in the top left inset), which is characteristic of long-range ferromagnetic ordering. Amorphous silicon before laser annealing shows a diamagnetic behavior (bottom right inset), where silicon dangling bonds between tetrahedra are saturated. The tetrahedra in as-implanted amorphous silicon are not as closely packed as in Q-silicon, and sp³ dangling bonds find their way to reconstruct. On the other hand, in amorphous Q-silicon, the tetrahedra are closely packed, leaving dangling bonds between them. In addition, the dangling bonds at the interface between the amorphous and nanocrystalline regions can lead to dangling bonds.

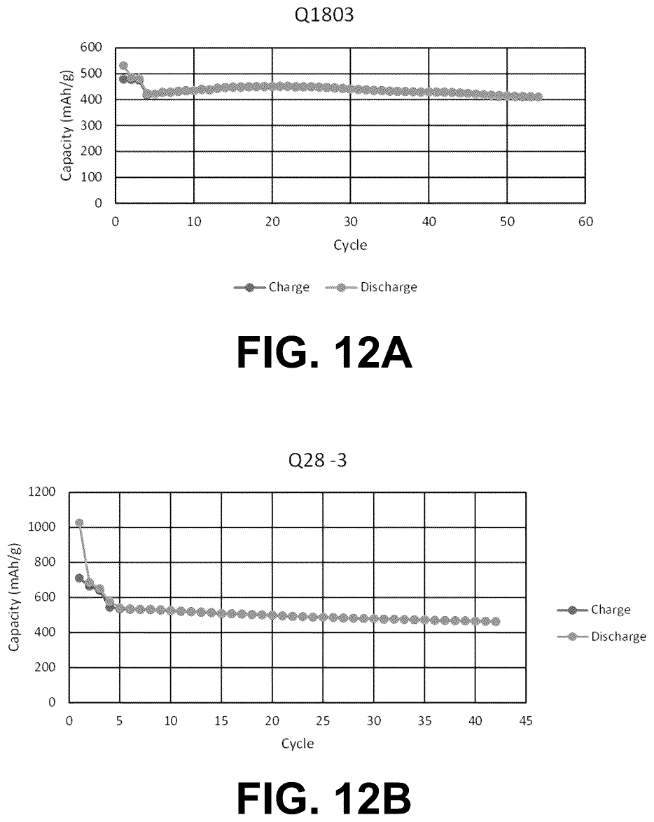

Q-carbon, Q-silicon, and a mixture of Q-carbon and Q-silicon can be used as anode materials with standard NMC 811 and LMNO as cathode materials in lithium ion batteries. Nanostructured Q-carbon and Q-silicon increase the number density of Li+ ion trapping sites and enhance the mobile Li+ ion concentration. FIGS. 12A and 12B illustrate examples of current capacity versus cycle for Q1 and Q2, respectively, obtained from experimental testing. The experimental results show drastic improvements in current capacity ranging from 450 mAh/g to 600 mAh/g for two different Q1 (FIG. 12A) and Q2 (FIG. 12B) samples with LiFePO4 cathodes. As the anode composition changes from Q-carbon to Q-carbon and Q-silicon mixtures, a further increase in current capacity was observed. This is compared to maximum theoretical current capacity of 372 mAh/g for graphite. By using nanostructured Q-carbon and Q-silicon anodes, similar improvements in performance are possible for other ionic (Na⁺, Mg²⁺, Al³⁺ ions) batteries. FIGS. 12A and 12B depict these results and show maintenance of high power with the number of cycles (>50K).

Furthermore, microstructural characteristics and defect engineering of currently used graphite anodes with NMC 811 and LiNi_{0.5}Mn_{1.5}O₄ cathodes after nanosecond pulsed laser annealing can be addressed to improve their performance and current capacity. The focus is on the creation of defects and surface steps, as well as removal of disordered carbon and inactive PVDF binder from graphite anode surfaces and regions in-between grains, using nanosecond pulsed laser. The pulsed laser annealing (PLA) treatment removes inactive binder (PVDF) from the top of grains and between the grains, and leads to formation of LiF coating. The LiF coating reduces Li ion plating and is beneficial for battery performance and life span.

The formation energy single vacancies (10 eV) and divacancies (8 eV) are quite high. According to DFT calculations, the migration energy for single vacancy is also quite high, but the migration energy for divacancy is considerably lower. Therefore, C-vacancies (V_{Cn}, n≥1) cannot be formed under thermodynamic equilibrium conditions. However, these defects can be formed under highly nonequilibrium conditions of pulsed laser annealing. The nanosecond laser annealing creates C-vacancies (V_{Cn}, n≥1), which can provide sites for Li⁺ ions during charging and enhances current carrying capacity during discharging. This increases number density of vacancies and sites for Li⁺ trapping and improves interaction with electrolytes which carry Li⁺ ions.

In addition, surface steps and steps at the grooves improve diffusion transport of lithium ions. The formation of vacancies in the basal planes of graphite active sites for Li⁺ ion trapping (charging) and detrapping (discharging), which can enhance current capacity. However, if this vacancy concentration is too high, crowding of Li⁺ ions can cause electron trapping, which can lead to formation of Li⁰ and lithium metal plating. The lithium plating can lead to formation lithium metal dendrites and sort circuiting safety hazard.

Q-silicon with atomic density 60% higher than crystalline silicon, while keeping the bonding characteristics the same as normal silicon has been disclosed. Distinct amorphous phases have been created, where one, two or three tetrahedra are randomly packed, and a crystalline phase of Q-silicon was formed, where subunit cells were arranged along <110> directions with alternate holes. Nanosecond laser melting of amorphous silicon in undercooled state and quenching has created Q-silicon with robust ferromagnetism compared to diamagnetism of silicon. The Curie temperature of Q-silicon is estimated to be over 400K, thus offering opportunities for spin-based computing and atomic-level storage.

Nanostructured anodes of Q-carbon, Q-silicon and their mixtures can improve current carrying capacity of lithium ion batteries significantly. This improvement ranges from 600 mAh/g to 2000 mAh/g, as the composition varies from Q-carbon to Q-silicon, compared to maximum theoretical capacity of 372 mAh/g for macrocrystalline graphite incurrent lithium ion batteries. Q-carbon, Q-silicon, and mixture of Q-carbon and Q-silicon can be utilized as anode materials with standard NMC 811 and LMNO as cathode materials in lithium ion batteries. By using nanostructured Q-carbon and Q-silicon anodes, similar improvements in performance can be achieved for other ionic (Na⁺, Mg²⁺, Al³⁺ ions) batteries. Nanostructured Q-carbon and Q-silicon increase the number density of Li⁺ ion trapping sites and enhance the mobile Li⁺ ion concentration. In addition, a pulsed laser annealing (PLA) treatment removes inactive binder (PVDF) from the top of grains and between the grains, leading to formation of a LiF coating. The LiF coating reduces Li ion plating and is beneficial for battery performance and life span.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include atomic concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y”.

Therefore, at least the following is claimed:

1. A method, comprising:
forming a layer of amorphous silicon;
melting at least a portion of the layer of amorphous silicon in an undercooled state; and
forming Q-silicon by quenching the melted amorphous silicon from the undercooled state.

2. The method of claim 1, wherein the layer of amorphous silicon is formed by irradiation by ions, physical vapor deposition or chemical vapor deposition.

3. The method of claim 1, wherein the amorphous silicon is melted by nanosecond laser pulsing.

4. The method of claim 3, wherein the nanosecond laser pulsing is at an energy density in a range between about 0.1 J/cm⁻² and about 0.3 J/cm⁻².

5. The method of claim 1, wherein the Q-silicon comprises randomly arranged tetrahedra having dangling bonds and unpaired spins between the tetrahedra.

6. The method of claim 1, wherein the Q-silicon is amorphous Q-silicon or crystalline Q-silicon based upon a time in the undercooled state.

7. The method of claim 1, wherein the Q-silicon is doped with a dopant.

8. The method of claim 7, wherein the dopant is boron.

9. The method of claim 7, wherein dopant concentrations exceed a thermodynamic solubility limit of the dopant in silicon.

10. A Q-silicon, comprising:
a random arrangement of tetrahedra, the tetrahedra comprising dangling bonds, unpaired spins or both, wherein atomic structure of the Q-silicon is based upon time in an undercooled state before quenching.

11. The Q-silicon of claim 10, wherein the tetrahedra are doped with a dopant.

12. The Q-silicon of claim 11, wherein the dopant is boron in a concentration exceeding a thermodynamic solubility limit of boron in silicon.

13. The Q-silicon of claim 10, wherein the atomic structure is amorphous or crystalline.

14. A battery anode, comprising:
Q-silicon mixed with a polyvinylidene difluoride (PVDF) binder, the Q-silicon comprising a random arrangement of tetrahedra, the tetrahedra comprising dangling bonds, unpaired spins or both.

15. The battery anode of claim 14, comprising Q-carbon and the Q-silicon mixed with the PVDF binder.

16. The battery anode of claim 14, wherein the tetrahedra are doped with a dopant.

17. The battery anode of claim 14, comprising a LiF coating formed in a surface of the Q-silicon.

18. The battery anode of claim 17, wherein the LiF coating is formed by pulsed laser annealing removing the PVDF binder from top of and between grains of the Q-silicon.

19. The battery anode of claim 14, wherein the Q-silicon mixed with the PVDF binder is disposed on a substrate.
